(19) United States
(12) Patent Application Publication
(10) Pub. No.: US 2016/0349964 A1
(43) Pub. Date: Dec. 1, 2016

(54) METHOD AND COMPUTING DEVICE FOR PERFORMING OPERATION ON ICON CELL

(71) Applicant: TENCENT TECHNOLOGY (SHENZHEN) COMPANY LIMITED, Shenzhen (CN)

(72) Inventor: YULONG WANG, Shenzhen (CN)

(73) Assignee: TENCENT TECHNOLOGY (SHENZHEN) COMPANY LIMITED

(21) Appl. No.: 15/236,950

(22) Filed: Aug. 15, 2016

Related U.S. Application Data
(63) Continuation of application No. PCT/CN2015/082618, filed on Jun. 29, 2015.

(30) Foreign Application Priority Data
Jun. 30, 2014 (CN) 2014-10307033.0

(51) Int. Cl. G06F 3/0481; G06F 3/0484; G06F 9/44

(52) U.S. Cl. CPC G06F 3/04817; G06F 9/4443; G06F 3/04842

(57) ABSTRACT

A method for performing an operation on an icon cell includes: receiving a first instruction, input by a user, for performing a first operation on a first icon cell and a second icon cell, the first icon cell being any icon cell on a software interface, and the second icon cell being any other icon cell on the software interface; performing the first operation on the first icon cell and the second icon cell according to the first instruction if the first operation satisfies a predetermined matching rule; and determining whether the instruction input by the user disappears, and performing a predetermined operation on the icon cell on the software interface according to the matching rule if the instruction disappears.

### CROSS-REFERENCES TO RELATED APPLICATIONS

This application is a continuation application of PCT Patent Application No. PCT/CN2015/082618, filed on Jun. 29, 2015, which claims priority to Chinese Patent Application No. 201410307033.0, entitled “METHOD AND COMPUTING DEVICE FOR PERFORMING OPERATION ON ICON CELL” filed on Jun. 30, 2014, the entire contents of both of which are incorporated herein by reference.

### FIELD OF THE TECHNOLOGY

The present disclosure relates to the field of computer technologies, and in particular, to a method and a computing device for performing an operation on an icon cell.

### BACKGROUND OF THE DISCLOSURE

In an operation on a desktop of a terminal or some software, an operation such as connection or exchange needs to be performed on an icon cell on a desktop or a software interface.

In the existing technology, a matching rule is generally preconfigured in software, and only two (or more) icon cells that satisfy the matching rule can be connected or exchanged. Moreover, the connection or exchange operation is generally irreversible. Once the operation is completed, a subsequent action is triggered, and a reverse operation cannot be performed for the connection or exchange operation, so that an operating method is not flexible enough.

### SUMMARY

An embodiment of the present invention provides a method for performing an operation on an icon cell, including: receiving a first instruction, input by a user, for performing a first operation on a first icon cell and a second icon cell, the first icon cell being any icon cell on a software interface, and the second icon cell being any other icon cell on the software interface; performing the first operation on the first icon cell and the second icon cell according to the first instruction if the first operation satisfies a predetermined matching rule; and determining whether the instruction input by the user disappears, and performing a predetermined operation on the icon cell on the software interface according to the matching rule if the instruction disappears.

Correspondingly, an embodiment of the present invention further provides a computing device for performing an operation on an icon cell, including: a first receiving unit, configured to receive a first instruction, input by a user, for performing a first operation on a first icon cell and a second icon cell, the first icon cell being any icon cell on a software interface, and the second icon cell being any other icon cell on the software interface; a first executing unit, configured to perform the first operation on the first icon cell and the second icon cell according to the first instruction if the first operation satisfies a predetermined matching rule; a determining unit, configured to determine whether the instruction input by the user disappears; and a second executing unit, configured to perform a predetermined operation on the icon cell on the software interface according to the matching rule if the first instruction disappears.

Other aspects of the present disclosure can be understood by those skilled in the art in light of the description, the claims, and the drawings of the present disclosure.

### BRIEF DESCRIPTION OF THE DRAWINGS

To describe the technical solutions of the embodiments of the present invention or the existing technology more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a schematic flowchart of a method for performing an operation on an icon cell according to Embodiment 1 of the present invention;

FIG. 2 is a first schematic flowchart of a method for performing an operation on an icon cell according to Embodiment 2 of the present invention;

FIG. 3 is a second schematic flowchart of a method for performing an operation on an icon cell according to Embodiment 2 of the present invention;

FIG. 4 is a third schematic flowchart of a method for performing an operation on an icon cell according to Embodiment 2 of the present invention;

FIG. 5 is a fourth schematic flowchart of a method for performing an operation on an icon cell according to Embodiment 2 of the present invention;

FIG. 6 is a first schematic structural diagram of a computing device for performing an operation on an icon cell according to Embodiment 3 of the present invention;

FIG. 7 is a second schematic structural diagram of a computing device for performing an operation on an icon cell according to Embodiment 3 of the present invention; and

FIG. 8 illustrates a block diagram of an exemplary computer system consistent with the disclosed embodiments.

### DESCRIPTION OF EMBODIMENTS

The following clearly describes the technical solutions in the embodiments of the present invention in detail with reference to the accompanying drawings. Apparently, the described embodiments are merely a part rather than all of the embodiments of the present invention. All other embodiments obtained by a person of ordinary skill in the art based on the embodiments of the present invention without creative efforts shall fall within the protection scope of the present disclosure.

In the specification, claims and the accompanying drawings of the present disclosure, the terms “first”, “second”, “third”, “fourth”, and the like (if existing) are used to distinguish the similar objects, and are unnecessarily used for describing the specific order or sequence. It should be noted that, the terms used in this way can be interchanged with one another, so that the embodiments of the present invention described herein can be implemented in other sequences than those shown or described herein. In addition, the terms “comprises”, “comprising,” and any other variation thereof are intended to cover a non-exclusive inclusion. For example, a process, method, computing device, product, or device that includes a list of steps or units is not necessarily limited to those steps or units, but may optionally further include other steps or units not expressly listed or inherent to such a process, method, product, or device.

The method as disclosed as following may be implemented by any appropriate computing device having one or more processors and a memory. The computing device, used herein, may refer to any appropriate device with certain computing capabilities (e.g., for performing an operation on an icon cell), such as a personal computer (PC), a work station computer, a hand-held computing device (tablet), a mobile terminal (a mobile phone or a smart phone), a server, a network server, a smart terminal, or any other user-side or server-side computing device. The memory includes a storage medium, which may further include memory modules, e.g., Read-Only Memory (ROM), Random Access Memory (RAM), and flash memory modules, and mass storages, e.g., a CD-ROM, a U-disk, a removable hard disk, etc., which are all non-transitory storage mediums. The storage medium may store computer programs for implementing various processes, when executed by the processors.

### Embodiment 1

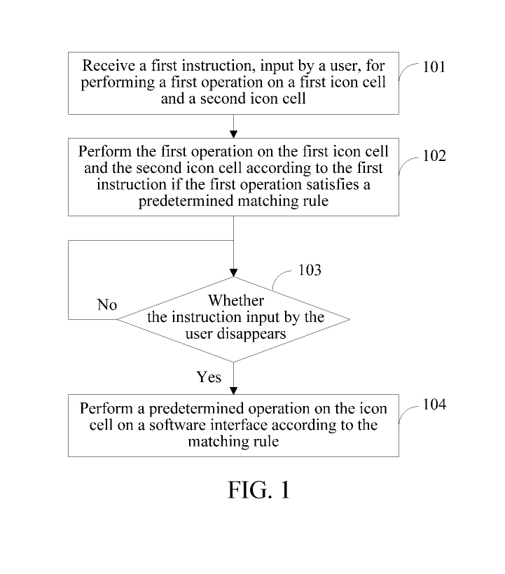

This embodiment of the present invention provides a method for performing an operation on an icon cell. As shown in FIG. 1, the method includes the following steps.

101: Receiving a first instruction, input by a user, for performing a first operation on a first icon cell and a second icon cell, where the first icon cell is any icon cell on a software interface, and the second icon cell is any other icon cell on the software interface.

102: Performing the first operation on the first icon cell and the second icon cell according to the first instruction if the first operation satisfies a predetermined matching rule.

103: Determining whether the instruction input by the user disappears, and if the instruction disappears, performing 104; otherwise, performing 103.

104: Performing a predetermined operation on the icon cell on the software interface according to the matching rule.

In the method for performing an operation on an icon cell according to this embodiment, after a first operation is performed on a first icon cell and a second icon cell according to a first instruction, a subsequent action is not triggered immediately according to a matching rule; and a corresponding operation is not triggered until the first instruction disappears or stops; and in this way, a user has a chance to input another instruction to perform another operation, for example, an operation that is reverse to the first instruction, on the first icon cell and the second icon cell. Therefore, compared with the existing technology, the method for performing an operation on an icon cell according to this embodiment is more flexible and can improve user experience of the user.

### Embodiment 2

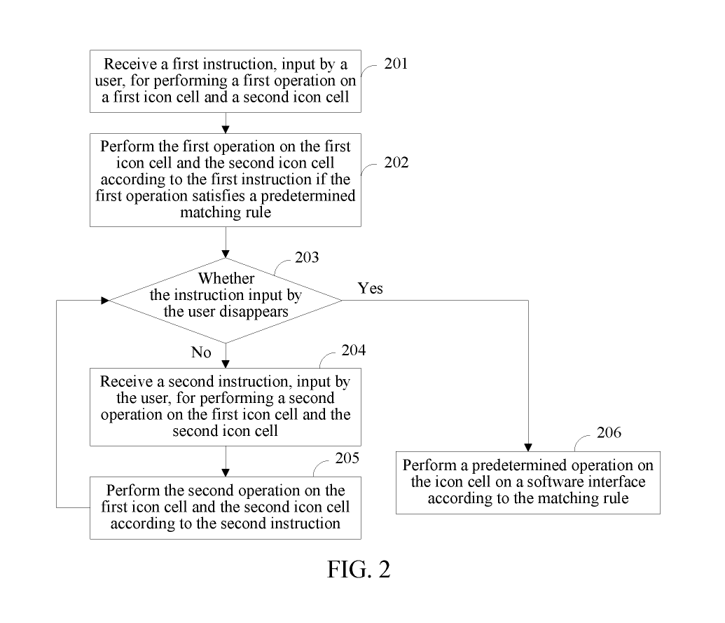

This embodiment of the present invention provides a method for performing an operation on an icon cell. As shown in FIG. 2, the method includes the following steps.

201: Receiving a first instruction, input by a user, for performing a first operation on a first icon cell and a second icon cell, where the first icon cell is any icon cell on a software interface, and the second icon cell is any other icon cell on the software interface.

202: Performing the first operation on the first icon cell and the second icon cell according to the first instruction if the first operation satisfies a predetermined matching rule.

203: Determining whether the instruction input by the user disappears, and if the instruction disappears, performing 206; otherwise, performing 204.

204: Receiving a second instruction, input by the user, for performing a second operation on the first icon cell and the second icon cell.

205: Performing the second operation on the first icon cell and the second icon cell according to the second instruction, and perform 203.

206: Performing a predetermined operation on the icon cell on the software interface according to the matching rule.

In the method for performing an operation on an icon cell according to this embodiment, after a first operation is performed on a first icon cell and a second icon cell according to a first instruction, a subsequent action is not triggered immediately according to a matching rule; and a corresponding operation is not triggered until the first instruction disappears; before the first instruction disappears, a user can input a second instruction to perform a second operation on the first icon cell and the second icon cell. Therefore, compared with the existing technology, the method for performing an operation on an icon cell according to this embodiment is more flexible and can improve user experience of the user.

For example, the first instruction and the second instruction may be input by the user by using an input apparatus of a terminal device, for example, in a manner of clicking a mouse or touching a touch screen of the terminal. A manner of inputting the first instruction and the second instruction is not specifically limited herein.

That the instruction input by the user disappears may refer to that the terminal detects that a signal of the user input instruction on the first icon cell and the second icon cell disappears. For example, the user relaxes a finger that clicks the mouse, or a finger of the user moves away from the touch screen of the terminal. In another example, the first instruction may be triggered when the user clicks/taps the first icon cell and subsequently clicks/taps the second icon cell. The second instruction may be triggered when the user clicks/taps one of the first icon cell and the second icon cell after the first instruction is received. The instruction input by the user may be considered as disappeared when the user clicks/taps a third icon cell or clicks/taps at places other than the first icon cell and the second icon cell.

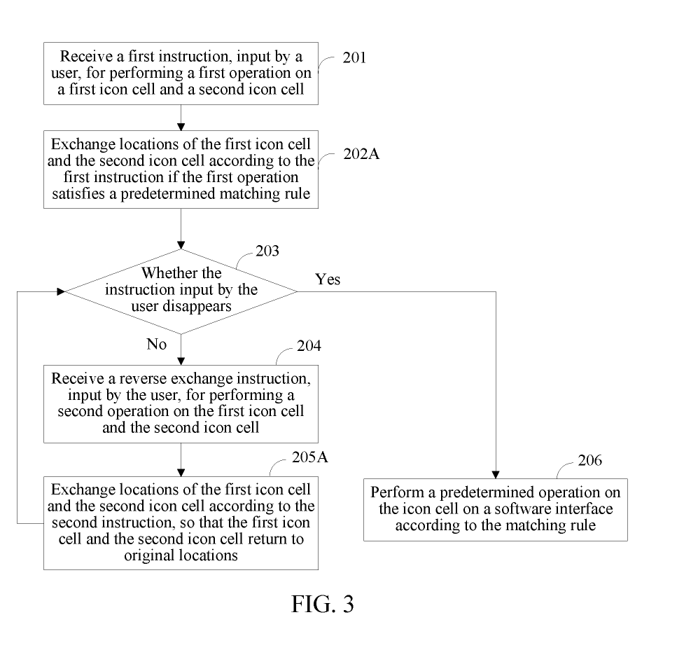

For example, the first operation may be an exchange operation, that is, an operation of instructing location exchange between the first icon cell and the second icon cell. Correspondingly, as shown in FIG. 3, step 202 may further include the following steps.

202A: Exchanging the locations of the first icon cell and the second icon cell according to the first instruction if the first operation satisfies the predetermined matching rule.

Specifically, coordinate index values of the first icon cell and the second icon cell may be exchanged, so as to exchange the locations of the first icon cell and the second icon cell on the software interface. In some embodiments, the location exchange may be displayed on the software interface with an animation effect.

For example, the second operation may be a reverse exchange operation, that is, an operation of instructing reverse location exchange between the first icon cell and the second icon cell, so that the first icon cell and the second icon cell return to original locations. Correspondingly, as shown in FIG. 3, step 205 may include the following.

205A: Exchanging locations of the first icon cell and the second icon cell according to the second instruction, so that the first icon cell and the second icon cell return to original locations. In some embodiments, the location returning may be displayed on the software interface with an animation effect.

Specifically, the coordinate index values of the first icon cell and the second icon cell may be exchanged again, so that the first icon cell and the second icon cell return to the original locations on the software interface.

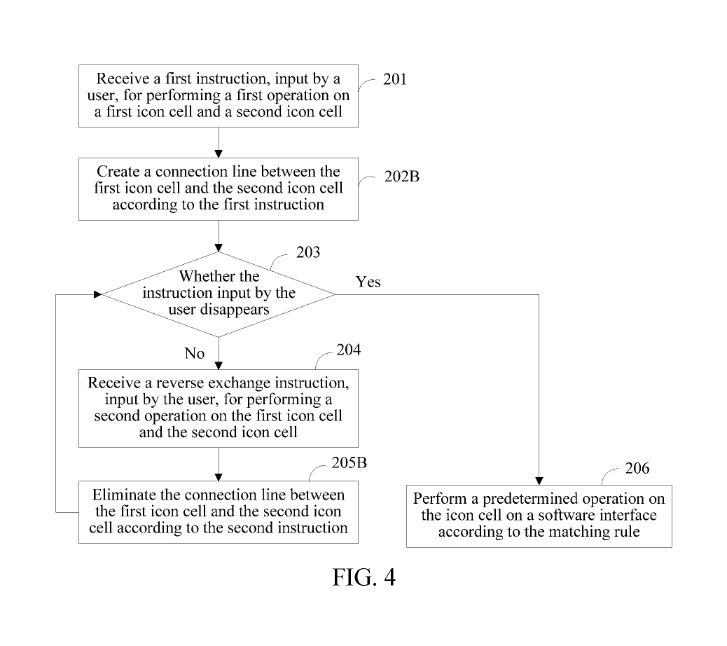

For example, the first operation may also be a connection operation, that is, an operation of instructing connection line creation between the first icon cell and the second icon cell. Correspondingly, as shown in FIG. 4, step 202 may further include the following.

202B: Creating the connection line between the first icon cell and the second icon cell according to the first instruction.

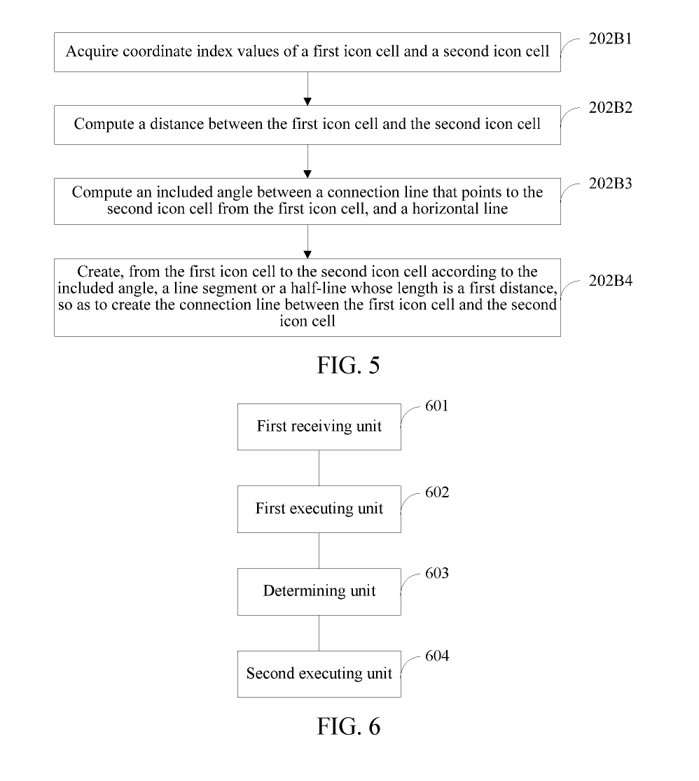

For example, as shown in FIG. 5, step 202B may include the following.

202B1: Acquiring the coordinate index values of the first icon cell and the second icon cell.

202B2: Computing a distance between the first icon cell and the second icon cell.

202B3: Computing an included angle between the connection line that points to the second icon cell from the first icon cell, and a horizontal line.

202B4: Creating, from the first icon cell to the second icon cell according to the included angle, a line segment or a half-line whose length is a first distance, so as to create the connection line between the first icon cell and the second icon cell, where the first distance is a distance between the first icon cell and the second icon cell. In some embodiments, the created connection line is displayed on the software interface.

For example, the second operation may be a reverse connection operation, that is, an operation of instructing elimination of the connection line created between the first icon cell and the second icon cell. Correspondingly, as shown in FIG. 4, step 205 may include the following.

205B: Eliminating the connection line between the first icon cell and the second icon cell according to the second instruction. In some embodiments, the connection line previously displayed on the software interface is eliminated when the second operation is performed.

For example, in step 206, after the instruction input by the user disappears, a subsequent operation, for example, eliminating, combining, zooming in or zooming out an icon cell that satisfies the matching rule, may be performed on the icon cell (e.g., the first icon cell and the second icon cell) on the software interface according to the matching rule, after the first operation (and the second operation) is already performed on the software interface. In some embodiments, when the instruction input by the user disappears after the first operation is performed (e.g., the first and second icon cells are connected or exchanged location), the subsequent operation may be performed, such as eliminating both the first and second icon cells, or combining the first and second icon cells with neighboring icon cells; and when the instruction input by the user disappears after the second operation is performed (i.e., the reversed operation is performed), no subsequent operation is performed because the first and second icon cells are returned to their original status.

For example, the method for performing an operation on an icon cell according to this embodiment of the present invention may be applied to application programs such as an application of an elimination category and an application of a connection category. Certainly, an application scope of the method for performing an operation on an icon cell according to this embodiment of the present invention is not limited hereto. The method for performing an operation on an icon cell may also be applied to another related field, which is not specifically limited herein.

### Embodiment 3

This embodiment of the present invention provides a computing device for performing an operation on an icon cell. As shown in FIG. 6, the computing device includes: a first receiving unit 601, configured to receive a first instruction, input by a user, for performing a first operation on a first icon cell and a second icon cell, the first icon cell being any icon cell on a software interface, and the second icon cell being any other icon cell on the software interface; a first executing unit 602, configured to perform the first operation on the first icon cell and the second icon cell according to the first instruction if the first operation satisfies a predetermined matching rule; a determining unit 603, configured to determine whether the instruction input by the user disappears; and a second executing unit 604, configured to perform a predetermined operation on the icon cell on the software interface according to the matching rule if the first instruction disappears.

In the computing device for performing an operation on an icon cell according to this embodiment, after a first operation is performed on a first icon cell and a second icon cell according to a first instruction, a subsequent action is not triggered immediately according to a matching rule; and a corresponding operation is not triggered until the first instruction disappears; and in this way, a user has a chance to input another instruction to perform another operation, for example, an operation that is reverse to the first instruction, on the first icon cell and the second icon cell. Therefore, compared with the existing technology, the computing device for performing an operation on an icon cell according to this embodiment is more flexible and can improve user experience of the user.

For example, the first instruction and the second instruction may be input by the user by using an input apparatus of a terminal device, for example, in a manner of clicking a mouse or touching a touch screen of the terminal. A manner of inputting the first instruction and the second instruction is not specifically limited herein.

That the instruction input by the user disappears may refer to that the terminal detects that a signal of the user input instruction disappears. For example, the user relaxes a finger that clicks the mouse, or a finger of the user moves away from the touch screen of the terminal.

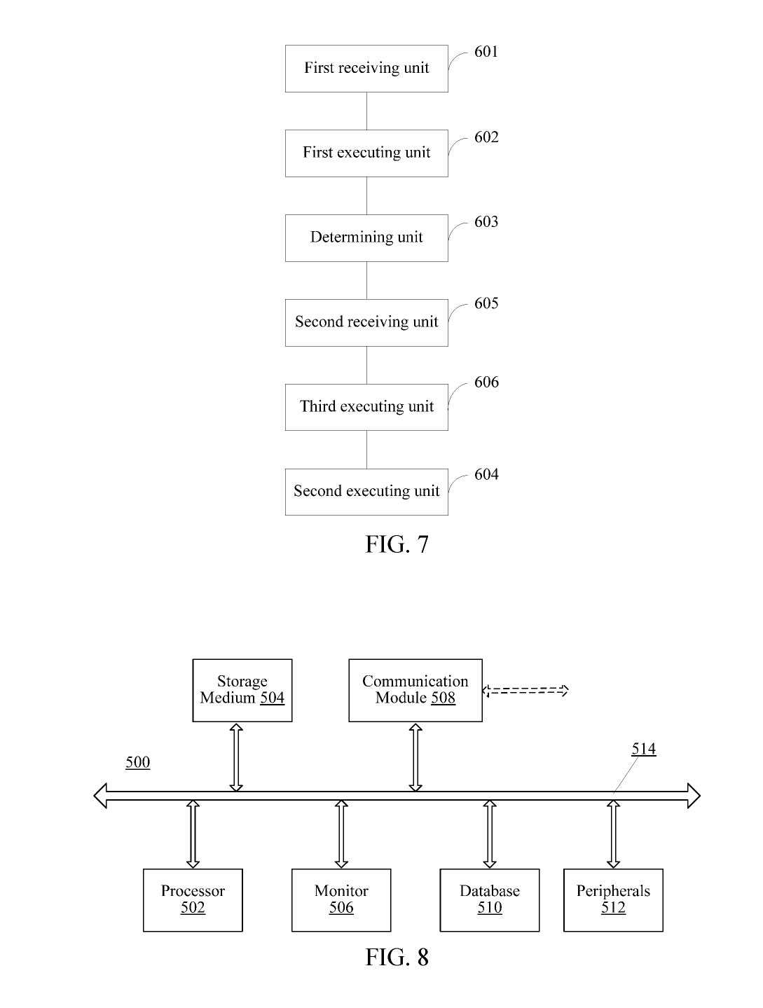

Further, as shown in FIG. 7, the computing device may further include: a second receiving unit 605, configured to: before the first instruction disappears, receive a second instruction, input by the user, for performing a second operation on the first icon cell and the second icon cell; and a third executing unit 606, configured to perform the second operation on the first icon cell and the second icon cell according to the second instruction.

For example, the first operation is an exchange operation, that is, an operation of instructing location exchange between the first icon cell and the second icon cell. Correspondingly, the first executing unit 602 may be further configured to exchange the locations of the first icon cell and the second icon cell according to the first instruction if the first operation satisfies a predetermined matching rule.

For example, the second operation may be a reverse exchange operation, that is, an operation of instructing reverse location exchange between the first icon cell and the second icon cell, so that the first icon cell and the second icon cell return to original locations. Correspondingly, the third executing unit 604 may be further configured to exchange locations of the first icon cell and the second icon cell according to the second instruction, so that the first icon cell and the second icon cell return to the original locations.

For example, the first operation may also be a connection operation, that is, an operation of instructing connection line creation between the first icon cell and the second icon cell. Correspondingly, the first executing unit 602 may be further configured to create the connection line between the first icon cell and the second icon cell according to the first instruction if the first operation satisfies the predetermined matching rule.

For example, the first executing unit 602 may include: a coordinate acquiring subunit, configured to acquire coordinate index values of the first icon cell and the second icon cell; a distance computing subunit, configured to compute a distance between the first icon cell and the second icon cell; an angle computing subunit, configured to compute an included angle between the connection line that points to the second icon cell from the first icon cell, and a horizontal line; and a connection line creating subunit, configured to create, from the first icon cell to the second icon cell according to the included angle, a line segment or a half-line whose length is a first distance, so as to create the connection line between the first icon cell and the second icon cell, where the first distance is a distance between the first icon cell and the second icon cell.

For example, the second operation may also be a reverse connection operation, that is, an operation of instructing elimination of the connection line created between the first icon cell and the second icon cell. Correspondingly, the third executing unit 604 may be further configured to eliminate the connection line between the first icon cell and the second icon cell according to the second instruction.

The disclosed embodiments use two icon cells for illustrative purposes. It is understood that, the embodiments can be extended to scenarios with more than two icon cells. For example, the first operation may be a connection operation for connecting three icon cells. The second operation may be a reverse connection operation for disconnecting the latest connected icon cell or disconnecting all connected icon cells.

In some embodiments, the icon cells on the software interface may be described by one or more properties/features, such as category, location, color, size, shape, pattern, texture, etc. Each icon cell may have a corresponding feature value for each feature type. The predetermined matching rule may include rules for determining whether the icon cells involved in an operation are matching, e.g., icon cells having a same/similar (or opposite) feature value in a specific feature type, or icon cells satisfying multiple feature value requirements. For example, the matching rule may include determining icon cells having a same shape and belonging to a same category as matching icon cells. In another example, the matching rule may include determining icon cells having complementary shapes are matching icon cells.

The disclosed computing device, and/or various disclosed modules and units may be implemented using one or more computing systems. FIG. 8 illustrates an exemplary computing system consistent with the disclosed embodiments.

As shown in FIG. 8, a computing system 500 may include a processor 502, a storage medium 504, a monitor 506, a communication module 508, a database 510, peripherals 512, and one or more bus 514 to couple the devices together. Certain devices may be omitted and other devices may be included.

The processor 502 can include any appropriate processor or processors. Further, the processor 502 can include multiple cores for multi-thread or parallel processing. The storage medium 504 may include memory modules, e.g., Read-Only Memory (ROM), Random Access Memory (RAM), and flash memory modules, and mass storages, e.g., CD-ROM, U-disk, removable hard disk, etc. The storage medium 504 may store computer programs for implementing various processes (e.g., running an application for manipulating icon cells according to user inputs, maintaining a software interface for presenting the icon cells and operations performed on the icon cells, determining whether an operation on the icon cells satisfies a matching rule), when executed by the processor 502.

The monitor 506 may include display devices for displaying contents in the computing system 500, such as displaying, on a software interface, effects on the icon cells (e.g., connecting, exchanging position, eliminating, combining operations) according to user input by implementing the disclosed method. The peripherals 512 may include I/O devices, e.g., touchscreen, keyboard and mouse for inputting information by a user. The peripherals may also include certain sensors, such as speaker, microphone, etc.

Further, the communication module 508 may include network devices for establishing connections through a communication network such as Internet or other types of computer networks or telecommunication networks, either wired or wireless. The database 510 may include one or more databases for storing certain data (e.g., icon cells, properties and features of the icon cells, matching rules, etc.) and for performing certain operations on the stored data.

In operation, the computing system 500 may receive a user input on the icon cells by the keyboard or touch screen 512 or transmitted from another device through the communication module 508, implement the disclosed method to process the user input and perform corresponding operations on the icon cells based on user input by the processor 502, and display the process result on the monitor 506. Specifically, the computing system 500 may receive a first instruction, input by a user, for performing a first operation on a first icon cell and a second icon cell, the first icon cell being any icon cell on a software interface, and the second icon cell being any other icon cell on the software interface; perform the first operation on the first icon cell and the second icon cell according to the first instruction if the first operation satisfies a predetermined matching rule; and determine whether the instruction input by the user disappears, and performing a predetermined operation on the icon cell on the software interface according to the matching rule if the instruction disappears.

The disclosed method and system may be applied in various graphical applications that involve icons or labels. In one example, the disclosed method may be used in a tile-matching puzzle game application, such as connect 2 games, match three games, etc. The game application may detect user operations of selecting icon cells and releasing selection, and determine whether to remove the icon cells based on the user operations and matching rules. In another example, the disclosed method may be used in an application icon managing interface.

It should be noted that the foregoing embodiments are based on a same inventive concept. Description of each embodiment has particular emphasis, and for the part, not described in detail, of each embodiment, reference may be made to description in other embodiments.

A person of ordinary skill in the art may understand that all or some of the steps in methods of the foregoing embodiments may be implemented by a program instructing relevant hardware. The program may be stored in a computer readable storage medium. The storage medium may include: a flash disk, a ROM, a RAM, a magnetic disk, an optical disc or the like.

The foregoing describes a method and a computing device for performing an operation on an icon cell according to the embodiments of the present invention in detail. Specific examples are used herein to explain principles and implementation manners of the present disclosure, and description of the following embodiments is only used to help understand the method of the present disclosure and core concept thereof. Meanwhile, a person of ordinary skill in the art may make variations in specific implementation manners and the application scope according to the conception of the present disclosure. In conclusion, content of the present description should not be understood as a limitation to the present disclosure.

1. A method for performing an operation on an icon cell, comprising:
at a computing device having one or more processors and a memory storing programs executed by the one or more processors,
receiving a first instruction, input by a user, for performing a first operation on a first icon cell and a second icon cell, the first icon cell being any icon cell on a software interface, and the second icon cell being any other icon cell on the software interface;
performing the first operation on the first icon cell and the second icon cell according to the first instruction if the first operation satisfies a predetermined matching rule; and
determining whether the instruction input by the user disappears, and performing a predetermined operation on the icon cell on the software interface according to the matching rule if the instruction disappears;
wherein the method further comprises:
before the first instruction disappears, if a second instruction, input by the user, for performing a second operation on the first icon cell and the second icon cell is received, performing the second operation on the first icon cell and the second icon cell according to the second instruction; and
wherein when the first instruction is a connection operation, and the second operation is a reverse connection operation,
the performing the first operation on the first icon cell and the second icon cell according to the first instruction comprises: creating a connection line between the first icon cell and the second icon cell according to the first instruction; and
the performing the second operation on the first icon cell and the second icon cell according to the second instruction comprises: eliminating the connection line between the first icon cell and the second icon cell according to the second instruction.

2. (canceled)

3. The method according to claim 1, wherein when the first instruction is an exchange operation, and the second operation is a reverse exchange operation,
the performing the first operation on the first icon cell and the second icon cell according to the first instruction comprises:
exchanging locations of the first icon cell and the second icon cell according to the first instruction; and
the performing the second operation on the first icon cell and the second icon cell according to the second instruction comprises:
exchanging locations of the first icon cell and the second icon cell according to the second instruction, so that the first icon cell and the second icon cell return to original locations.

4. (canceled)

5. The method according to claim 1, wherein the establishing a connection line between the first icon cell and the second icon cell comprises:
acquiring coordinate index values of the first icon cell and the second icon cell;
computing a distance between the first icon cell and the second icon cell;
computing an included angle between the connection line that points to the second icon cell from the first icon cell, and a horizontal line; and
creating, from the first icon cell to the second icon cell according to the included angle, a line segment or a half-line whose length is a first distance, so as to create the connection line between the first icon cell and the second icon cell, wherein the first distance is a distance between the first icon cell and the second icon cell.

6. A computing device for performing an operation on an icon cell, comprising:
a plurality of program modules comprising computer-implemented instructions stored in a memory of a computing device and executed by one or more processors of the computing device, the plurality program modules comprising:
a first receiving unit, configured to receive a first instruction, input by a user, for performing a first operation on a first icon cell and a second icon cell, the first icon cell being any icon cell on a software interface, and the second icon cell being any other icon cell on the software interface;
a first executing unit, configured to perform the first operation on the first icon cell and the second icon cell according to the first instruction if the first operation satisfies a predetermined matching rule;
a determining unit, configured to determine whether the instruction input by the user disappears; and
a second executing unit, configured to perform a predetermined operation on the icon cell on the software interface according to the matching rule if the first instruction disappears
wherein the computing device further comprises:
a second receiving unit, configured to: before the first instruction disappears, receive a second instruction, input by the user, for performing a second operation on the first icon cell and the second icon cell; and
a third executing unit, configured to perform the second operation on the first icon cell and the second icon cell according to the second instruction
wherein when the first instruction is an exchange operation, and the second operation is a reverse exchange operation,
the first executing unit is further configured to exchange locations of the first icon cell and the second icon cell according to the first instruction if the first operation satisfies the predetermined matching rule; and
the third executing unit is further configured to exchange locations of the first icon cell and the second icon cell according to the second instruction, so that the first icon cell and the second icon cell return to original locations.

7-8. (canceled)

9. The computing device according to claim 6, wherein when the first instruction is a connection operation, and the second operation is a reverse connection operation;
the first executing unit is further configured to create a connection line between the first icon cell and the second icon cell according to the first instruction if the first operation satisfies the predetermined matching rule; and
the third executing unit is further configured to eliminate the connection line between the first icon cell and the second icon cell according to the second instruction.

10. The computing device according to claim 9, wherein the first executing unit comprises:
a coordinate acquiring subunit, configured to acquire coordinate index values of the first icon cell and the second icon cell;
a distance computing subunit, configured to compute a distance between the first icon cell and the second icon cell;
an angle computing subunit, configured to compute an included angle between the connection line that points to the second icon cell from the first icon cell, and a horizontal line; and
a connection line creating subunit, configured to create, from the first icon cell to the second icon cell according to the included angle, a line segment or a half-line whose length is a first distance, so as to create the connection line between the first icon cell and the second icon cell, wherein the first distance is a distance between the first icon cell and the second icon cell.

11. A non-transitory computer readable storage medium having stored therein one or more instructions, which, when executed by a computing device, cause the computing device to:
receive a first instruction, input by a user, for performing a first operation on a first icon cell and a second icon cell, the first icon cell being any icon cell on a software interface, and the second icon cell being any other icon cell on the software interface;
perform the first operation on the first icon cell and the second icon cell according to the first instruction if the first operation satisfies a predetermined matching rule; and
determine whether the instruction input by the user disappears, and perform a predetermined operation on the icon cell on the software interface according to the matching rule if the instruction disappears;
wherein the one or more instructions further cause the computing device to:
before the first instruction disappears, if a second instruction, input by the user, for performing a second operation on the first icon cell and the second icon cell is received, perform the second operation on the first icon cell and the second icon cell according to the second instruction; and
wherein when the first instruction is a connection operation, and the second operation is a reverse connection operation,
the performing the first operation on the first icon cell and the second icon cell according to the first instruction comprises: creating a connection line between the first icon cell and the second icon cell according to the first instruction; and
the performing the second operation on the first icon cell and the second icon cell according to the second instruction comprises: eliminating the connection line between the first icon cell and the second icon cell according to the second instruction.

12. The non-transitory computer readable storage medium according to claim 11, wherein when the first instruction is an exchange operation, and the second operation is a reverse exchange operation;
the performing the first operation on the first icon cell and the second icon cell according to the first instruction comprises: exchanging locations of the first icon cell and the second icon cell according to the first instruction; and
the performing the second operation on the first icon cell and the second icon cell according to the second instruction comprises: exchanging locations of the first icon cell and the second icon cell according to the second instruction, so that the first icon cell and the second icon cell return to original locations.

13. The non-transitory computer readable storage medium according to claim 11, wherein the establishing a connection line between the first icon cell and the second icon cell comprises:
acquiring coordinate index values of the first icon cell and the second icon cell;
computing a distance between the first icon cell and the second icon cell;
computing an included angle between the connection line that points to the second icon cell from the first icon cell, and a horizontal line; and
creating, from the first icon cell to the second icon cell according to the included angle, a line segment or a half-line whose length is a first distance, so as to create the connection line between the first icon cell and the second icon cell, wherein the first distance is a distance between the first icon cell and the second icon cell.
